(19) United States
(12) Patent Application Publication
(10) Pub. No.: US 2021/0094233 A1
(43) Pub. Date: Apr. 1, 2021

(54) 3D PRINTING SYSTEM

(71) Applicant: HEWLETT-PACKARD DEVELOPMENT COMPANY, L.P., Spring, TX (US)

(72) Inventors: Randall WEST, Vancouver, WA (US); Justin M. ROMAN, Vancouver, WA (US); Alexander David LAWS, Vancouver, WA (US); Jeffrey BERGESON, Vancouver, WA (US); Kevin HULICK, Corvallis, OR (US)

(21) Appl. No.: 17/050,781

(22) PCT Filed: Sep. 28, 2018
(86) PCT No.: PCT/US18/53314

§ 371 Date: Oct. 26, 2020

(51) Int. Cl. B29C 64/329; B33Y 40/00; B01F 13/02

(52) U.S. Cl. CPC B29C 64/329; B01F 13/02; B33Y 40/00

(57) ABSTRACT

A 3D printing system comprises a pressure system to provide a negative pressure and a hopper having a first opening to receive powder to be used for printing, wherein the powder is received in an open state of the first opening. The hopper has a second opening to guide air from outside the hopper to inside the hopper and has a third opening connected to the pressure system so as to provide for a negative pressure inside the hopper, the negative pressure to overcompensate for the air receive through the second opening such that a pressure being lower when compared to an ambient pressure of the hopper is generated inside the hopper.

### BACKGROUND

A 3D printing system may use powder to be printed into three-dimensional objects. The powder may be stored in and dispersed from a suitable container being referred to as a hopper.

### BRIEF DESCRIPTION OF THE DRAWINGS

Examples will now be described, by way of non-limiting example only, with reference to the accompanying drawings, in which:

FIG. 1 shows a schematic block diagram of a part of an example 3D printing system;

FIG. 2 shows a schematic block diagram of a part of an example 3D printing system comprising a hopper having a fourth opening being connected to a tubing

FIG. 3 shows a schematic block diagram of a configuration of the hopper which may be used in connection with the 3D printing system of FIG. 1 and/or FIG. 2;

FIG. 4 shows a schematic block diagram of a configuration of the hopper that may be used it the 3D printing system of FIG. 1 and/or FIG. 2 alternatively or in addition to the configuration of FIG. 3;

FIG. 5 shows a schematic block diagram of a 3D printing system according to an example, wherein a negative pressure system feeds a source of the hopper;

FIG. 6 shows a schematic block diagram of a 3D printing system according to an example, wherein interfaces may be used to isolate the hopper from the 3D printing system;

FIG. 7 is a schematic perspective view of a part of an example 3D printing system comprising interfaces, wherein each interface is connectable to a hopper;

FIG. 8 shows a schematic block diagram of a 3D printing system according to an example, having a humidifier; and

FIG. 9 shows a schematic flowchart of an example method for operating a 3D printing system.

### DETAILED DESCRIPTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present disclosure. However, examples of the present disclosure may be practiced without these specific details. In other instances, well known structures and devices are shown in block diagram form rather than in detail in order to avoid obscuring embodiments of the present disclosure. In addition, features of the different embodiments described hereinafter may be combined with each other, unless specifically noted otherwise.

Examples described herein relate to positive and negative pressure. A reference value of positive and negative pressure may be a pressure level surrounding a component to which pressure is applied. Some examples relate to pressurized hopper. A negative pressure described as being generated inside the hopper may a pressure being lower when compared to an ambient pressure or pressure on the outside of the hopper such as an atmospheric pressure. A negative pressure system in accordance with examples, may be external to the hopper and may provide for a pressure being lower than that of the hopper's pressure to induce a flow. Negative pressure used herein may be used to obtain a low internal hopper pressure to keep the 3D printing system and/or its environment clean. Alternatively or in addition, examples relate to negative pressure as being a source of pressure attached to a component such as a hopper to create this condition.

Describing the hopper so as to have a positive or negative pressure is used in the present disclosure to provide for a consistent description of examples. Some examples allow for subjecting the hopper with positive or ambient pressure and negative pressure at a same time whilst providing for a negative overall pressure inside the hopper. Based on different pressure levels at different locations, the hopper may have a pressure variation within it. Pumps or aerators pushing or blowing air into the hopper, e.g., through a membrane of a fluidizer, may lead to positive pressure in the region of the fluidizer, e.g., in the bottom of the powder. At a same time, a negative pressure system may suck off powder dust from the top of the hopper using the negative pressure system. Thereby positive to neutral to negative pressures may be present within the hopper or powder relative to outside ambient.

Generally, examples of the present disclosure relate to a 3D printing system that prints powder into three-dimensional objects, for example, by disposing a fluidized powder in a layer, followed by removing the fluid so as to form a layer of the three-dimensional structure. Examples are directed to 3D printing systems that utilize a container for holding the powder to be printed, being also referred to as a hopper. A hopper may comprise an inlet and an outlet for receiving and dispersing the powder. The inlet and the outlet may be referred to as openings in the hopper.

The openings may be connected to pipelines or tubings for transporting the powder. At the opening itself and/or as a part of the tubing, valves, airlocks and/or sensor elements may be arranged. Within the examples described herein, an arrangement of such structures in or at the opening or as a part of the tubing may be understood as equivalent solutions unless described otherwise.

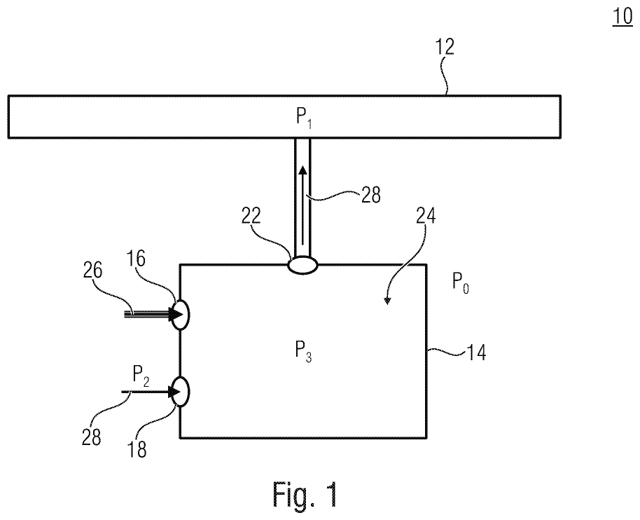

FIG. 1 shows a schematic block diagram of a part of a 3D printing system 10. The 3D printing system 10 comprises a pressure system or a negative pressure system 12 that generates or provides a negative pressure P₁ being lower when compared to an ambient pressure of a hopper 14 of the 3D printing system 10. The hopper 14 may comprise openings 16, 18 and 22, forming a connection between an interior 24 of the hopper 14 and an outside world of the hopper 14.

The opening 16 may allow to receive powder 26 to be used for printing. For receiving the powder 26, the opening 16 may comprise an open state. The opening 16 may have a normally closed configuration and/or may be connected to an airlock so as to allow for a tight sealing or even a hermetically sealing during times during which no powder 26 is inserted into the interior 24 of hopper 14.

The opening 18 is to guide air 28 from outside the hopper 14 to inside the hopper 14. The air 28 may be actively pressured or may be sucked into the interior 24 based on the negative pressure P₁ supplied by the pressure system 12 which is connected to the interior 24 via the opening 22.

The air 28 may comprise a pressure P₂ outside the hopper 14, wherein pressure P₂ may be, for example, an ambient pressure equal to pressure P₀ or higher. That is, the air 28 may lead to an increase in pressure inside the hopper 14, wherein the pressure system 12 leads to a decrease in the pressure inside the hopper 14, a combination of pressures P₂ and P₁ resulting in a pressure P₃ in the interior 24 of the hopper 14. The pressure P₁ may overcompensate for the pressure P₂, i.e., the air 28 received through the opening 18, such that the pressure P₃ is lower when compared to the pressure P₀. That is, despite sucking or even blowing the air 28 through the opening 18 into the hopper 14, a negative pressure compared to the ambient pressure Po may be obtained in the hopper 14. By way of example, the first opening 16 may comprise a state normally closed and/or the third opening 22 and the second opening 18 may each comprise a state normally open. This does not exclude to implement different configurations and to actively change the normal-state during normal operation, for example, to obtain a predefined state in case of a power loss.

This allows to avoid powder loss caused by imperfect seals of the hopper 14 and allows for a clean 3D printing system. A low amount of leaking powder allows for an improved user experience.

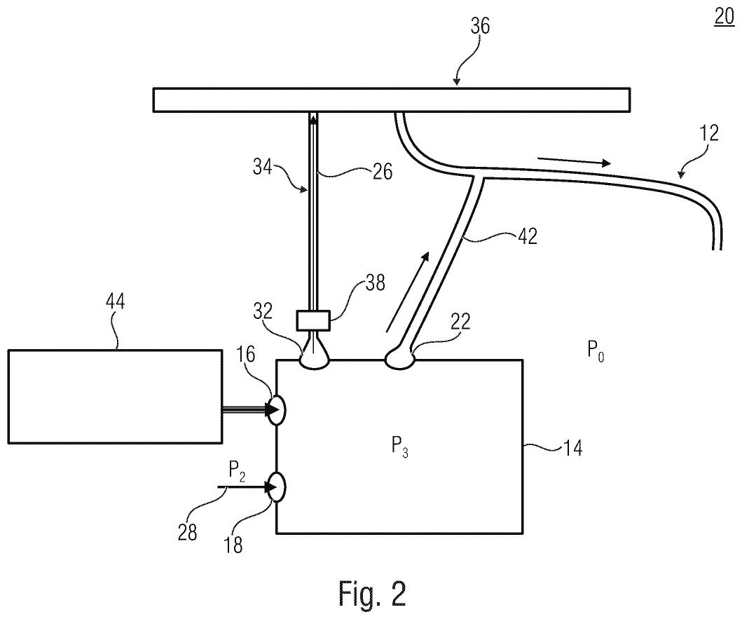

FIG. 2 shows a schematic block diagram of a part of a 3D printing system 20 comprising the hopper 14 having a further opening 32 being connected to a tubing 34 to guide the powder 26 to a building section 36 of the 3D printing system 20. The building section 26 may comprise, for example, a building table or a building chamber onto or into which the powder 26 is provided so as to be printed into a 3D object. The opening 32 is connected to an airlock 38. The 3D printing system 20 is to open the airlock 38 to extract the powder 26 from the hopper during a first instance of time so as to feed the 3D printing system 20, i.e., to provide for the powder 26 at the building section 36. The 3D printing system 20 is further to close the airlock 38 to prevent powder 26 from traveling through the airlock 38 during a second instance of time. The airlock 38 may be a part of the tubing 34 but may also be arranged as part of the opening 32 or the building section 36. The airlock 38 may include a single air locking element to be in an open or closed state. The airlock 38 may alternatively include a series of air locking elements arranged adjacent to each other or spaced from each other. A first air locking element may be arranged close to the opening 32 or as a part thereof, whilst a different air locking element may separate the tubing 34 from the building section 36.

Alternatively or in addition, the pressure system 12 may be connected to the printing section 36, i.e., it may be in communication with the building section 36. The pressure system 12 may be to remove unprinted powder from the building section 36, for example, powder that has dropped from a surface of a table, beside the 3D object and/or that is contained in the air of a building chamber. The opening 22 may be connected to the pressure system 12 using a suitable tubing 42. That is, the pressure system 12 may be used as well as for collecting unprinted powder as well as for generating the negative pressure P₃ in the hopper 14. Such a synergetic use of the pressure system 12 allows for simple and efficient printing systems.

The opening 16 may be in communication, i.e., connected to, a supply 44 containing the powder 26. For example, large amounts of powder 26 may be contained in the supply 44 and parts thereof may be transferred to the hopper 14. With regard to the ambient pressure Po, the openings 16, 22 and/or 32 may be tight or sealed. The seals may be hermetical but may also be a so-called make and break connection, for example, enabling the hopper 14 to be removed for certain purposes such as cleaning, replacement or the like.

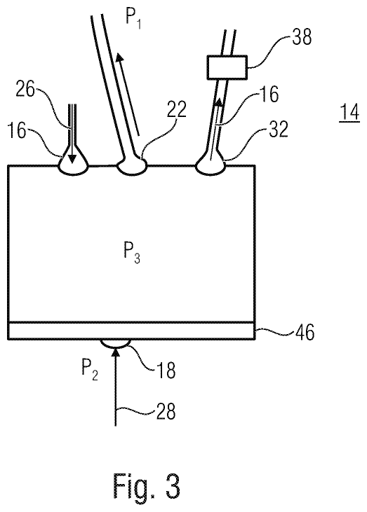

FIG. 3 shows a schematic block diagram of a configuration of the hopper 14 which may be used in connection with the 3D printing system 10 and/or 20. The hopper 14 may comprise a fluidizer 46, wherein the fluidizer 46 is to use the air 28 received through the opening 18 to wet the powder, i.e., to transfer humidity from the air 28 to the powder 16. Alternatively or in addition, the fluidizer may use the air received for mixing so as to obtain a fluidized powder. The airstream may be used for steering up the powder contained in the hopper 14. That is, the fluidizer may provide for aeration of the powder. The fluidizer 46 may comprise a porous structure that comprises holes to let the air 28 pass from a first side to another side to generate bubbles in the fluidized powder. For example, the fluidizer 46 may comprise a plat-like structure or a cylindric structure.

In examples, the hopper 14 is to receive the powder 26 and then further condition the powder by fluidization, e.g., fluidization with humidified air to alter or increase the moisture content of the powder. Such an air and powder mixture may be referred to as a dispersion. To aid in dispensing of the powder from the hopper 14 through the opening 32, to prevent the material inside the hopper 14 to become inhomogeneous, and/or to deposit at a bottom of the hopper 14, the fluidizer 46 may stir up the fluidized powder inside the hopper 14. Through the opening 32, the fluidized powder 16 may be dispensed, for example, to the building section 36. By use of the airlock 38, dispensing of the powder 16 may be performed intermittently, i.e., during specific instances of time.

The negative pressure may facilitate the air 28 passing through the opening 18. The negative pressure may generate the airstream by sucking the air 28 into the hopper such that aeration is obtained by the negative pressure.

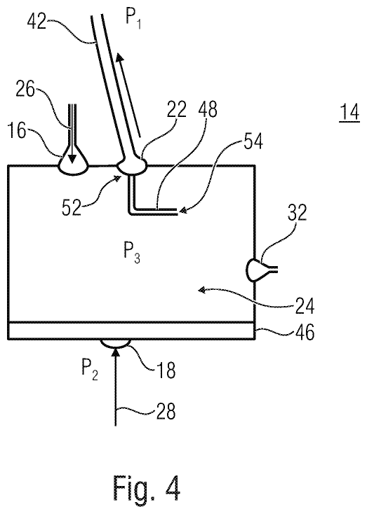

FIG. 4 shows a schematic block diagram of a configuration of the hopper 14 that may be used it the 3D printing system 10 and/or 20 alternatively or in addition to the configuration of FIG. 3. The hopper 14 comprises a tubing 48 that forms a snorkel inside the hopper 14, wherein the snorkel 48 may be connected to the opening 22 and/or 16. The openings 16 and 22 may be arranged adjacent to each other at the hopper 14. At the same time, the openings 16 and 22 may provide for different effects in the hopper 14, namely to feed the hopper 14 with the powder 26 through the opening 16 and to extract air through the opening 22. Based on their neighborhood, the powder 16 may be inserted into the hopper 14 adjacent to a location at which the air 28 is possibly extracted through the opening 22. This may occur, for example, in hoppers 14 that are modified, enhanced or amended by the opening 22, e.g., by way of an add-on solution. The snorkel 48 may allow for an increase in effective distance between the openings 16 and 22, for example, by arranging the snorkel 48 with a proximate and 52 at the opening 22, 16, respectively, and with a remote end 54 facing away from the respective other opening 16, 22, respectively. The snorkel 48 may allow to prevent that the powder 26 being just inserted into the hopper 14 is sucked out of the interior 24. Thus, the snorkel may allow for simple filters in the tubing 42.

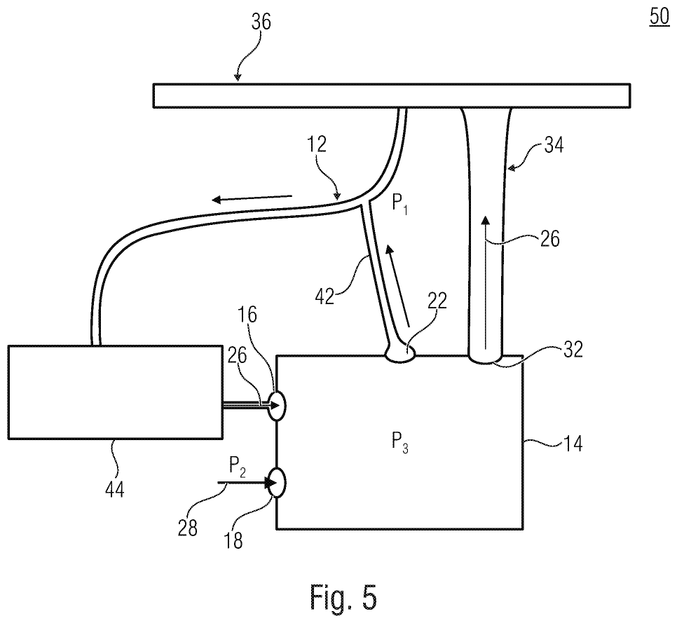

FIG. 5 shows a schematic block diagram of a 3D printing system 50 according to an example. When compared to the printing systems 10 and/or 20, the pressure system 12 may be connected to the building section 36 to remove unprinted powder from the building section 36. The pressure system 12 may further be connected to the supply 44, wherein the supply 44 may receive the powder from the building section 36, for example, directly or in a reconditioned or recycled fashion.

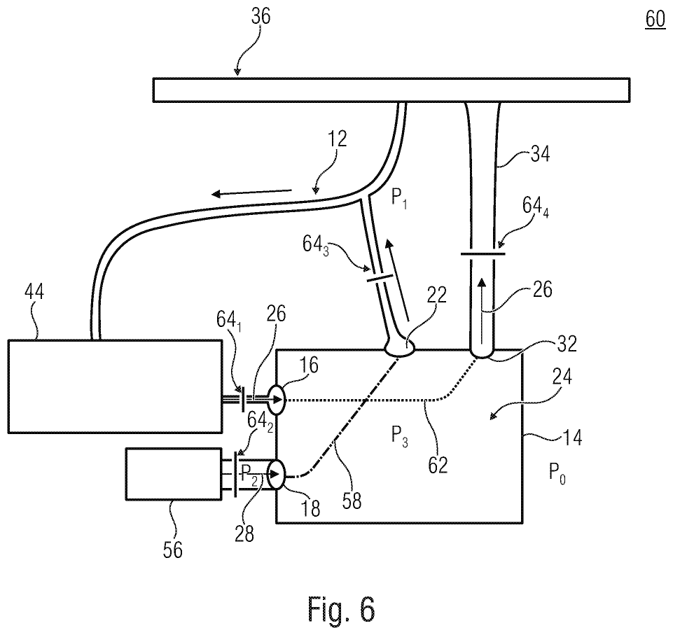

FIG. 6 shows a schematic block diagram of a 3D printing system 60 according to an example. When compared to the 3D printing system 50, the 3D printing system 60 comprises a positive pressure source to obtain an airflow of the air 28 into the interior 28. The pressure source may comprise, for example, a diaphragm pump, a blower or the like to provide the air stream. Thus, although examples, described herein relate to a pump, other pressure sources may be used to pump to pump the air 28 through the opening 18 into the interior 24 at the pressure P₂, i.e., the pressure P₂ may be an overpressure or positive pressure when compared to the ambient pressure P₀. For example, the air 28 may be supplied to the fluidizer 46.

A magnitude or pressure difference of the negative pressure P₁ with respect to the ambient pressure P₀ may be larger or higher when compared to a magnitude of the positive pressure P₂ with respect to the pressure P₀, i.e., the negative pressure P₁ may overcompensate the positive pressure P₀ such that the pressure P₃ is lower than the ambient pressure P₀. In other words, the negative pressure system 12 pulls air out of the hopper. This keeps the fluidized or aerosolized powder from exciting the hopper 14 through leaks in the various seals and interfaces. Negative pressure in the hopper may cause clean air to leak into the hopper rather than dirty or powdered air leaking out of the hopper.

The hopper 14 may comprise an air traveling path 58 and a powder traveling path 62. The air traveling path 58 may be formed between the openings 18 and 22, wherein the powder traveling path 62 may be formed between the openings 16 and 32. Although meeting each other in the interior 24, the respective paths may comprise distinct openings. The air traveling path 58 lets the air 28 travel from the opening 18 to the opening 22, wherein the powder traveling path 62 lets the powder 26 travel from the opening 16 to the opening 32.

When compared to the hopper described in connection with FIG. 3, the pressure source 56 may provide for aeration using positive pressure. The pressure induced thereby may be compensated using the negative pressure. According to an example, aeration using positive and negative pressure is combined, e.g., the negative pressure facilitates the air stream of the air 28, i.e., the negative pressure may facilitates or help to move air through the fluidizer, e.g., a membrane at the bottom of the hopper, by drawing air inwards. This in turn creates aeration that may be referred to as negative pressure aeration.

Further, the 3D printing system 60 may comprise interfaces 64₁, 64₂, 64₃ and/or 64₄ allowing to interrupt, make, or break a connection between the hopper 14 and respective attached component such as the supply 44, the pump 56, the pressure system 12 and/or the building section 36. This allows to remove the hopper 14 for different purposes such as a replacement or the like.

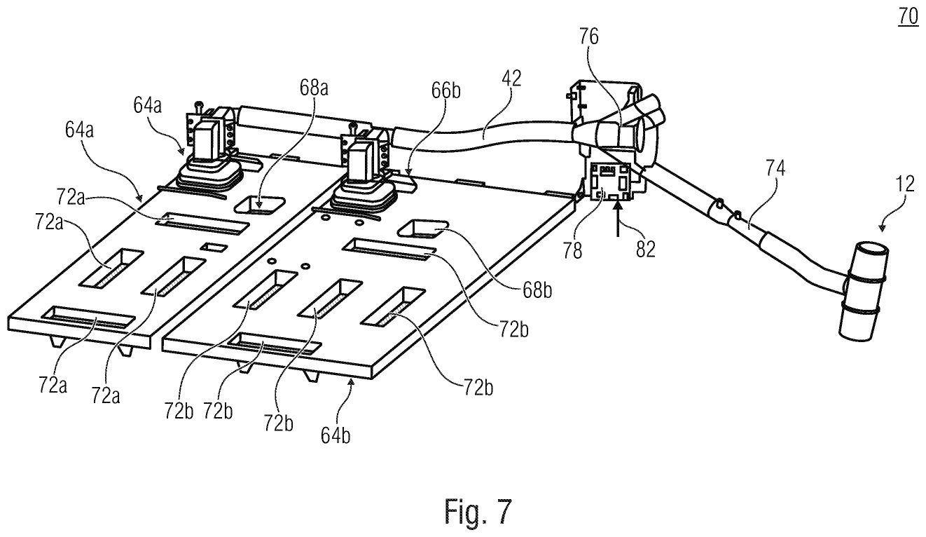

FIG. 7 is a schematic perspective view of a part of an example 3D printing system 70 comprising interfaces 64a and 64b, wherein each interface 64a and 64b is connectable to a hopper. Attachments 66a and 66b may be connected to respective openings 22 of the respective hopper, wherein holes 68a and 68b may be connected to other or further openings in the hopper, e.g., the openings 32. Further openings 72a in the interface 64a and openings 72b in the interface 64b allow to connected to further openings in the hoppers.

At the attachments 66a and 66b and/or at a sensor 74 being part of the tubing 42, a pressure in the tubing 42 and/or subjected to the respective hopper may be monitored. The 3D printing system 70 may comprise a regulator valve 76 to regulate an amount of air traveling through the opening 22 of the hopper 14, i.e., an amount of negative pressure subjected to the hopper. The 3D printing system 70 may comprise a control unit 78 to control an opening state of the regulator valve 76 so as to at least partially compensate for a time invariant pressure in the hopper 14. The regulator valve 76 in combination with the venturi 74 may be used to regulate the amount of airflow leaving the hoppers. The regulator valve 76 can also be used as a switch to isolate both the MRS (pressure source 12) and PCS (hoppers 14) system during various modes, for example, during a filter shake, where a connection of both systems is to be avoided because of airflow from the PCS-system, the pneumatic system 86, could undermine the filter cleaning function.

The regulator valve 76 thus be controlled so as to break an airflow from the hoppers to the pressure system 12, i.e., it may be controlled to a closed state. This allows for separating the hoppers from the pressure system 12 and may thus allow for operating at one side of the system whilst preventing effects on the other side. I.e., the regulator valve 76 allows to control the airflow and allows to isolate different sub-systems for specific modes of operation. The regulator valve 76 may change its position in reaction to different pressures in the pressure source 12, different leakage rates/defects, different states of the hopper such as if the hopper is full of powder, i.e., some leaks may not be as exposed such that a lower degree of magnitude in the negative pressure may be sufficient when compared to an empty hopper.

The control unit 78 may be implemented as a controller comprising a microprocessor, a central processing unit, a field programmable gate array (FPGA) or other configurations. The control unit 78 may receive a signal 82 containing information about a state in or at the hopper 14, a pressure in the pressure system 12, e.g., a signal measured with the sensor 74 and/or other information such as a leakage rate in a pressure system of the 3D printing system or the like. The control unit 78 may control an opening state of the regulator valve 76 so as to control the pressure in the hopper. The control unit may control the regulator valve according to a preselected or present hopper state.

A state of the hopper may relate to a variety of variations that may occur inside a hopper. For example, a hopper state may be related to a hopper aeration flow rate, e.g., a flow rate through the fluidizer, through the second opening. It may alternatively or in addition include an air flow rate through the third opening. The hopper state may relate to an operating mode of the hopper. For example, during an extract mode while powder is extracted from the hopper, we controller may close the regulator valve and have different pressure rules in effect when compared to a collect mode in which powder is inserted into the hopper. For example, different degrees of filling in the hopper may be associated with different pressures to be applied in the interior 24. The fluidization of the powder may be associated with a total volume expansion of the air/powder mixture, i.e. the higher the degree of fluidization, the higher the level of air/powder mixture in the hopper 14. By way of example, a higher degree of filling may require less air 28 to prevent the powder/air mixture from overflowing the hopper 14. The change in flow rate of air 28 may be associated with an increase in the magnitude of the negative pressure, e.g., the more full the hopper 14, the lower the flow rate of air 28, and the higher the magnitude of the negative pressure may be. Alternatively or in addition, a cleanliness of the 3D printing system may be used to control the regulator valve. For example, more airflow allowed may lead to a lower hopper pressure, which leads to less chance for leakage. Thus, a selected level of cleanliness may be associated with the volume flow or pressure in the hopper and thus be controlled by the controller.

Alternatively or in addition to use a hopper state as basis for control, the control unit may use related parameters, i.e., information or status of other components and/or other information of the hopper or parts as the basis for controlling the regulator valve. For example, a device generating the negative pressure may be monitored instead of the hopper or in addition hereto to obtain information about the effect that is currently obtained in the hopper. An example 3D printing system may include a pressure vessel that may be arranged downstream from the hopper, e.g., connected to the third opening. The vessel may be charge to negative pressure with respect to the hopper, e.g., by pulling air out of it. That is, the vessel may pull air from the hopper. The pressure inside the vessel may be monitored alternatively or in addition to monitoring the pressure in the hopper so as to allow for simple hoppers. For example, this allows to make sure that a cleaning function may be performed, e.g., as long as the vessel is charged. Alternatively or in addition to a pressure vessel, an active device can be used as described in connection with examples, i.e., negative pressure may be obtained at different locations in the system. Such an active device may be monitored alternatively or in addition to the hopper. For example, ff a blower or fan is used as pressure source, a flow rate may be measured and correlated with a pressure in the hopper.

Alternatively or in addition, a pressure supplied by the pressure system 12 may be time variant, for example, due to different amounts of air sucked by the negative pressure at the building section or the like. The control unit 78 may at least partially compensate for such variances by control of the regulator valve 76. Alternatively or in addition, the control unit 78 may increase the magnitude of the negative pressure, i.e., may further decrease the absolute pressure, responsive to an increase of a leakage rate of leaking air, i.e., the more air lost, the lower the absolute pressure is.

The control unit 78 may control the regulator valve 76 based on more than one parameter. For example, the control unit 78 may control the regulator valve 76 so as to control the negative pressure inside the hopper to a predefined hopper pressure level, e.g., according to a target or objective “maintain −1.5, −1.0 or −0.5” or any other suitable value of inches in water column or any other pressure scale. A second parameter may be an obtained volume flow through the regulator valve 76 or the sensor 74. For example, the sensor 74 may comprise a venturi. By way of example, the second parameter may be controlled according to “keep the airflow below 1 CFM (cubic foot per minute), do not exceed 2 CFM, 4 CFM or any other suitable value. Different or additional but also less targets may be given. That is, the control unit may control the regulator valve so as to control the negative pressure inside the hopper to a predefined hopper pressure level and simultaneously to control an airflow through the regulator valve to a predefined airflow level. This may include to keep the hopper pressure level within a predefined tolerance range and the keep the airflow below a predefined airflow level. Instead of the venturi, the sensor 74 may comprise sensor elements to measure a pressure P or any other related parameter present at the opening 22 and/or at a negative pressure section to which the negative pressure system is connected to apply negative pressure, e.g., the tubing 42 or the building section 36.

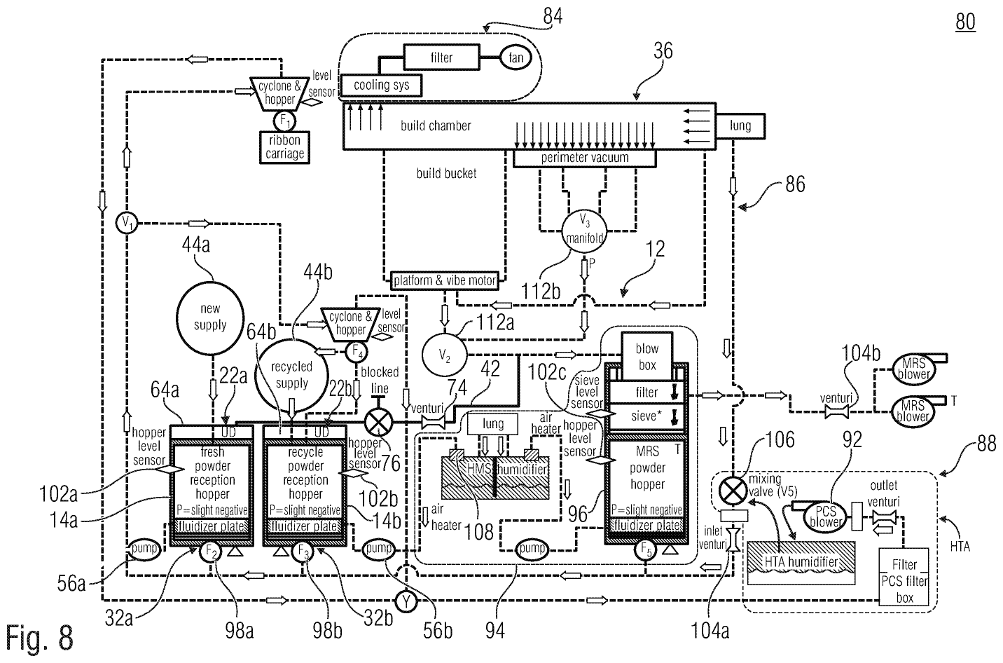

FIG. 8 shows a schematic block diagram of a 3D printing system 80 according to an example, wherein the 3D printing system is in accordance with the examples described in connection with the 3D printing system 10, 20, 50, 60 and/or 70.

The 3D printing system 80 may comprise a the shown number of two hoppers 14a and 14b but may also have a different number of hoppers, wherein the 3D printing system 80 is described as having hoppers 14a and 14b. Examples provide for printing systems that have one hopper, three hoppers, four hoppers or even a higher number.

The pressure system 12 is connected to the building section 36 being implemented as a building chamber, i.e., a volume that may be positively or negatively pressurized. A clean air management system may cool, filter and/or evacuate the build chamber 36. Further, a pneumatic system 86 may comprise a negative pressure that allows for transporting humidified air from a humidifier 88 that may be used inside the hopper 14 to wet the powder so as to obtain the mentioned dispersion in the hopper. That is, moisture may be added to the air upstream from where the powder is added to the air 28

The humidifier 88 may comprise a blower 92 that generates the negative pressure in the pneumatic system 86. In particular, the pneumatic system 86 may provide the build chamber 36 with the powder from the hoppers 14a and 14b. Further, the pneumatic system 86 may transport powder from a material recycling system (MRS) 94 having an MRS hopper 96 that receives the powder by use of the pressure system 12 from the build chamber 36. As described for hopper 14, the MRS hopper 96 may comprise a fluidizer that receives humidified air from a pump 56c. A humidity management system (HMS) allows for controlling a level of humidity of the powder. A filter 108 may allow to obtain filtered air that may be pumped by pump 56b into the hopper 14b. Further, the pressure system 12 may generate a negative pressure in the build chamber 36 so as to remove unprinted powder from the build chamber 36.

The pneumatic system 86 may thus be a pressure system that may be used for generating the negative pressure in the hoppers 14a and 14b alternatively or in addition to the pressure system 12.

In accordance with states of feeders 98a, 98b and 98c connected to openings 38a and 38b of the hoppers, to the hopper 96 respectively, the powder may be removed from the hoppers 14a and 14b and/or 96 so as to supply the build chamber 36 or, alternatively, powder may be transported from the hoppers 14a, 14b and/or 96 to the supply 44b.

Various sensors such as hopper level sensors 102a, 102b and 102c to output signals indicating a degree of filing of the hopper 14a, 14b and 96 respectively, a level sensor 102c communicating with the hopper 96 venturis such as the venturi 104a of the pneumatic system 86 or the venturi 104b of the pressures system 12 may provide information as well as temperature, pressure and/or moisture sensors (not shown). Such information may be used for controlling the state of the regulator valve 76, for regulating other valves such as mixing valve 106 providing the humidified air from the humidifier 88 and/or for controlling or regulating the power, speed or airflow of pumps 56a, 56b and/or 56c.

Valves 112a and/or 112b of the pressure system 12 may be controllable to different opening states, thereby resulting in different levels of pressure in the pressure system 12. As the tubing 42 is connected to the pressure system 12 in the present example, this may lead to a varying negative pressure being the source for generating the negative pressure in the hopper 14a and/or 14b. By use of the sensor 74 and the regulator valve 76, for example, a constant pressure or at least a pressure compensating for the variations in the pressure system 12 may be obtained in the hoppers 14a and 14b.

Examples described herein relate to a negative pressure architecture to prevent powder loss from hoppers. Examples provide for a system of addressing powder leakage in hoppers.

Examples include a negative pressure source, the pressure source 12, a regulator valve, the regulator valve 76, and a vessel to hold powder, i.e., the hopper 14. Examples address a leakage issue that might be caused by a positive pressure inside a hopper. Because embodiments relate to pulling air from the hoppers, for example, from the top of the hoppers, the aeration of the live bottom hoppers, i.e., hoppers comprising the fluidizers at the bottom, may be partially or fully driven by negative pressure which may also be referred to as negative pressure live bottom hoppers. Examples allow to reduce or avoid effects that could occur due to dynamic seals, i.e., make/break connections, a aeration, i.e., positively pressuring the hopper so as to fluidize the hoppers to help condition the powder and to facilitate level and extraction and/or the like. I.e., examples allow for simple implementations of dynamic seals, make/break connections and further components. Embodiments utilize a pressure tubing 42 and connections to the hoppers, a servo valve, i.e., regulator valve 76, a venturi 74 (flow meter) and a connection to an existing negative pressure system such as a material recovery system or the pneumatic system 86. As a material recovery system may already have a filter, additional filters may be avoided.

Examples use components of a source of negative pressure, e.g., the MRS sub-system, a vessel that holds powder that may leak at interfaces, e.g., hoppers, a throttling valve, e.g., regulator valve 76, a connection tubing 42 and possibly pressure sensors. Further examples are implemented without a throttling valve, for example, if the negative pressure source is constant. Alternatively or in addition, the use of an external pump/blower/fan may be used instead of a negative pressure region. This may be implemented in combination with a filter, a citation box or other filtration systems.

By putting the interior 24 of the hopper 14 in negative pressure, the aeration plate/fluidizer plates in the bottom of the hoppers may become a negative pressure live bottom hopper. Examples may be implemented with no additional filters, especially when connecting the hoppers, i.e., the tubing 42 with an existing sub-system already operating at negative pressure such as a MRS-system or the pneumatic system 86.

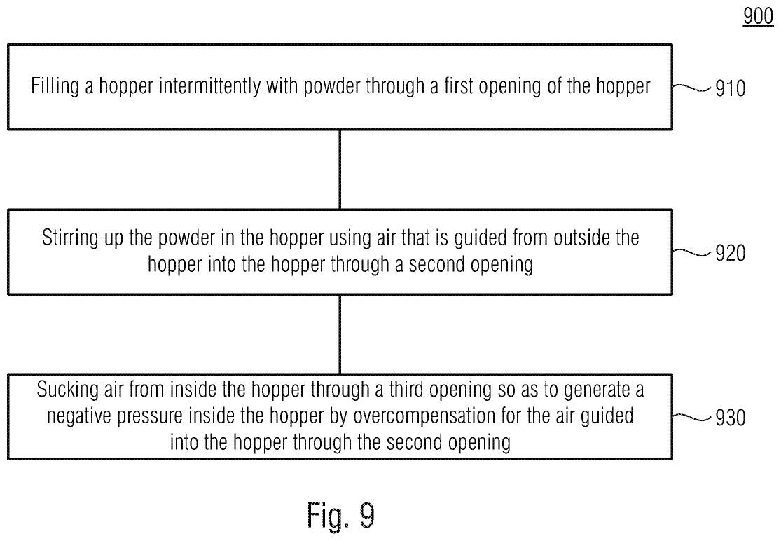

FIG. 9 shows a schematic flowchart of a method 900 according to an example. At 910, a hopper is filled intermittently with powder through a first opening of the hopper. At 920, the powder is mixed with air and fluidized in the hopper using air that is guided from outside the hopper into the hopper through a second opening. At 930, air is sucked from inside the hopper through a third opening so as to generate a negative pressure inside the hopper by overcompensating for the air guided to the hopper through the second opening.

Examples relate to a non-transitory machine-readable storage medium encoded with instructions executable by a processing resource of a computing device to perform methods described herein.

Examples described herein may be realized in the form of hardware, machine-readable instructions or a combination of hardware and machine-readable instructions. Any such machine-readable instructions may be stored in the form of volatile or non-volatile storage such as, for example, a storage device, such as a ROM, whether erasable or rewritable or not, or in the form of memory, such as, for example, RAM, memory chips, device or integrated circuits or an optically or magnetically readable medium, such as, for example, a CD, DVD, magnetic disk or magnetic tape. The storage devices and storage media are examples of machine-readable storage, that are suitable for storing a program or programs that, when executed, implement examples described herein.

All of the features disclosed in the specification including any accompanying claims, abstract and drawings, and/or all the features of any method or progress described may be combined in any combination including any claim combination, except combinations where at least some of such features are mutually exclusive. In addition, features disclosed in connection with a system may, at the same time, present features of a corresponding method, and vice versa.

Each feature disclosed in the specification including any accompanying claims, abstract and drawings may be replaced by other features serving the same, equivalent or a similar purpose, unless expressly stated otherwise. Thus, unless expressly stated otherwise, each feature disclosed is one example of a generic series of equivalent or similar features.

The foregoing has described the principles, examples and modes of operation. However, the teaching herein are not be construed as being limited to the particular examples described. The above-described examples are to be regarded as illustrative rather than restrictive, and it is to be appreciated that variations may be made in those examples without departing from the scope of the following claims.

1. A three-dimensional (3D) printing system comprising:
a pressure system to provide a negative pressure; and
a hopper having:
a first opening to receive powder to be used for printing, in an open state of the first opening;
a second opening to guide air from outside the hopper inside the hopper; and
a third opening connected to the pressure system so as to provide for negative pressure inside the hopper, the negative pressure to overcompensate for the air received through the second opening such that a pressure being lower when compared to a pressure outside the hopper is generated inside the hopper.

2. The 3D printing system of claim 1, wherein the hopper comprises:
a fluidizer to use the air received with the second opening for mixing the powder with the air to transfer moisture from the humidified air to the powder and for mixing to obtain a fluidized powder;
wherein the negative pressure is to facilitate mixing the powder with the air.

3. The 3D printing system of claim 2, wherein the second opening is connected to a positive pressure source to push air through the second opening to aerate the powder, whilst the negative pressure overcompensates for positive pressure generated by pushing the air; and
wherein the negative pressure is to facilitate an air stream through the second opening into the hopper to thereby aerate the powder.

4. The 3D printing system of claim 1, having a fourth opening to dispense the powder to a printing section of the 3D printing system, wherein the fourth opening is connected to an airlock, wherein the 3D printing system is to open the airlock to extract powder during a first instance of time so as to feed the 3D printing system and to close the airlock to prevent powder from travelling through the airlock during a second instance of time.

5. The 3D printing system of claim 1, comprising a positive pressure source to provide the air at positive pressure through the second opening into the hopper.

6. The 3D printing system of claim 1, wherein the pressure system is in communication with a printing section of the 3D printing system to suck unprinted powder from the printing section.

7. The 3D printing system of claim 1, comprising:
a regulator valve between the negative pressure system and the third opening, the regulator valve to regulate an amount of air travelling through the third opening; and
a control unit to control an opening state of the regulator valve so as to control the pressure in the hopper.

8. (canceled)

9. The 3D printing system of claim 7, wherein the control unit is to control the regulator valve based on at least one of a pressure level in the negative pressure system; a leakage rate of leaking air, a cleanliness level of the 3D printing system and a hopper state.

10. The 3D printing system of claim 9, wherein the control unit is to control the regulator valve so as to control the negative pressure inside the hopper to a predefined hopper pressure level and simultaneously to control an airflow through the regulator valve to a predefined airflow level; or wherein the control unit is to control the regulator valve so as to maintain the hopper pressure level within a predefined tolerance range and to keep the airflow below the predefined airflow level

11. The 3D printing system of claim 1, comprising a sensor to measure a pressure or a related parameter present at the third opening and, at a negative pressure section to which the negative pressure system is to apply negative pressure.

12. The 3D printing system of claim 1, wherein the hopper comprises an air travelling path to let air travel from the second opening to the third opening and comprises a powder travelling path to let powder travel from the first opening to a fourth opening being different form the second and third opening.

13. The 3D printing system of claim 1, wherein the first opening and the third opening are arranged adjacent to each other, wherein the hopper comprises a snorkel connected to the third opening inside the hopper to increase a distance between the first opening and an area of suctioning generated by the negative pressure.

14. The 3D printing system of claim 1, wherein the first opening comprises a state normally closed and wherein the third opening and the second opening comprises a state normally open.

15. A method for operating a 3D printing system, the method comprising:
filling a hopper intermittently with powder through a first opening of the hopper;
mixing the powder with air and fluidizing the powder in the hopper using air that is guided from outside the hopper into the hopper through a second opening; and
sucking air from inside the hopper through a third opening so as to generate a negative pressure inside the hopper by overcompensating for the air guided into the hopper through the second opening.
